(19) United States
(12) Patent Application Publication
(10) Pub. No.: US 2019/0179347 A1
(43) Pub. Date: Jun. 13, 2019

(54) Method of Operating Metering Devices

(71) Applicant: ProMinent GmbH, Heidelberg (DE)

(72) Inventors: Jens Kaibel, Lampertheim-Hofheim (DE); Markus Damnik, Bruhl (DE)

(21) Appl. No.: 16/325,294

(22) PCT Filed: Sep. 7, 2017
(86) PCT No.: PCT/EP2017/072422

§ 371 Date: Feb. 13, 2019

(30) Foreign Application Priority Data
Sep. 15, 2016 (DE) 10 2016 117 357.6

(51) Int. Cl. G05D 7/06

(52) U.S. Cl. CPC G05D 7/0676

(57) ABSTRACT

The present invention concerns a method of operating at least one metering device. To provide a method of operating metering devices, which can be flexibly adapted, it is proposed according to the invention that the method has the steps of providing a server, providing at least one metering device, providing a closed-loop control device, transmitting data, providing a case database, calculating improved further operating data and providing the improved further operating data for the control device.

The present invention concerns a method of operating at least one metering device. Metering devices generally have a metering chamber in which a displacement is reciprocable between two positions, wherein the volume of the metering chamber in the one position is greater than in the other position.

Such a metering device can be for example a diaphragm metering pump. Here a moveable diaphragm serves as the displacement element. In operation the metering chamber is connected to a suction line by way of a suction non-return valve and to a pressure line by way of a pressure non-return valve. Both the suction non-return valve and also the pressure non-return valve can be part of the metering device. They can however also be provided at the installation side.

When therefore the diaphragm is moved into the position in which the volume of the metering chamber is at its largest medium to be conveyed is sucked out of the suction line into the metering chamber by way of the suction valve. Following that the diaphragm is moved in the direction of that position in which the volume of the metering chamber is at its smallest. As a result the suction non-return valve is closed, whereupon the pressure in the metering chamber rises until the pressure non-return valve opens and the medium to be conveyed which is in the metering chamber is urged into the pressure line.

The metering device further has an actuator for driving the displacement element, which has an actuator input for an electrical actuation signal and which is so constructed that an electrical actuation signal at the actuator input is converted into a mechanical movement.

In the case of a metering diaphragm pump the diaphragm can be driven for example hydraulically so that the actuator includes a corresponding piston of which one face is in contact with the hydraulic fluid.

Alternatively the diaphragm could also be driven magnetically. For example the diaphragm could be fixedly connected to a thrust rod which is mounted in a magnet casing fixedly anchored in the pump housing, moveably axially in the longitudinal direction, so that the thrust rod and therewith the diaphragm upon electrical actuation of a magnetic coil is pulled into the magnet casing against the force of a compression spring into the bore in the magnet casing and after deactivation of the magnet the thrust rod moves back into the starting position again under the force of the compression spring so that upon continued activation and deactivation of the magnetic coil the diaphragm performs an oscillating movement. In that case the magnetic coil is to be viewed as the actuator.

In addition the metering device has a sensor for detecting a physical or chemical measurement value, which has a sensor output for an electrical measurement signal and which is so adapted that it detects the physical or chemical measurement value, converts it into an electrical measurement signal and makes it available at the sensor output. For example metering diaphragm pumps generally have such a sensor.

For example the pH-value of the medium to be conveyed could be detected in the pressure line. As an alternative thereto however the current and/or the voltage through the magnetic coil forming the actuator can also be detected. The sensor detects the corresponding measurement value in operation and converts the detected measurement value into an electrical measurement signal which it makes available at the sensor output. The sensor can thus measure for example an operational parameter of the metering device (for example current or voltage of the drive, position of the displacement element, pressure in the metering chamber) or an external parameter (for example the pH-value in the pressure or suction line, ambient temperature, air pressure and so forth).

EP 1 757 809 A1 describes a movement-controlled magnetic metering pump. That pump has as its sensor a position sensor which detects the position of the diaphragm or of the thrust rod connected to the diaphragm. The magnetic metering pump described there compares the detected position to a predetermined target value profile and controls the movement of the displacement element in such a way that the deviation between the actual position and the target position is as slight as possible.

The known metering device thus has a corresponding control device, by means of which controlled metering can be effected. The corresponding closed-loop control method is in that case placed in software stored within the metering device. In use of the pump inputs have to be implemented at the device itself in order to tell the metering device the form in which a corresponding closed-loop control is to be effected.

At more or less regular intervals the pump manufacturer develops improved control methods which however cannot be used directly by the metering device. For that purpose it is necessary for a suitable service technician to update on site the software on the metering device by means of a firmware update. With the progression in development higher and higher levels of computing and storage capacity are made available for the metering devices, with the consequence that older models of the metering devices can no longer be provided with current firmware updates as they no longer meet the corresponding computing and/or memory requirements. In that case it is then either necessary to forgo the improved control methods or the entire metering device has to be replaced.

Not infrequently the improved control methods permit enlargement of the area of use of the metering device, for example to provide extremely low metering speeds or metering of extremely viscous fluids to be delivered. In that way the same metering pump can admittedly be used in many more areas of application, but the demands on the hardware and software to be maintained in the metering device and the costs linked thereto rise. Those improved control methods however are in many cases not wanted at all by the user of the metering device as the metering pump is in any case only to be used on a known area of application and the demands in terms of observing an exact degree of metering accuracy are low. In those cases the provision of higher levels of computing and/or storage capacity is not necessary and unnecessarily drives up the costs of the metering device.

In addition the control parameters provided in the software are based on empirical values and model assumptions which were generally obtained within a test environment set up by the pump manufacturer. That test environment however is not suitable for all conceivable areas of use of the pump so that the control parameters are not necessarily optimum.

Taking the described state of the art as the basic starting point therefore the object of the invention is to provide a method of operating metering devices, which can be flexibly adapted.

According to the invention that object is attained by a method of operating at least one metering device, wherein the method comprises the steps:
A) providing a server,
B) providing at least one metering device having a metering chamber in which a displacement element is arranged moveably in such a way that it is reciprocable between two positions, wherein the volume of the metering chamber in the one position is greater than in the other position, wherein the metering device further has:
   an actuator for driving the displacement element, which has an actuator input for an electrical actuation signal and is so constructed that an electrical actuation signal at the actuator input is converted into a mechanical movement,
   a first sensor for detecting a physical or chemical measurement value which has a sensor output for an electrical measurement signal and is so adapted that it detects the physical or chemical measurement value, converts it into an electrical measurement signal and makes same available at the sensor output,
   a communication interface, by way of which the metering device can communicate with the server,
C) providing a closed-loop control device which receives the electrical measurement signal provided at the sensor output, compares it to a predetermined target value and in dependence on the comparison result and further operating data generates an electrical actuation signal and outputs it to the actuator input,
D) transmitting data which contain the electrical measurement signal or were calculated on the basis of the electrical measurement signal, from the metering device to the server by way of the communication interface,
E) providing a case database having reference data,
F) calculating improved further operating data from the transmitted data and the reference data, and
G) providing the improved further operating data for the control device.

According to the invention therefore a communication is made possible between the metering device and a separate server which is at best arranged remotely from the metering device, so that data which contain the electrical measurement signal or were calculated on the basis of the electrical measurement signal are transmitted from the metering device to the server by way of the communication interface. A case database having reference data is provided on the server side so that improved further operating data can be calculated from the transmitted data and the reference data and made available to the control device. Operating data for the control device can be for example the corresponding closed-loop control parameters. If model-based control is used for the control action, the operating data for the control device can also be a modified model.

In a preferred embodiment the transmitted data possibly together with at least a part of the further operating data or instead thereof data calculated from the transmitted data and possibly from at least a part of the operating data are recorded in the case database as further reference data.

The placement of reference data in the case database has the advantage that the most suitable operating data like for example the control parameters can be taken for various application situations.

As information about the quality of the control is also present by virtue of the measurement signal the entry in the case database can also be provided with a quality value representing a measurement in respect of control quality.

By virtue of the fact that the transmitted data are also entered in the case database the data pool, on the basis of which the improved further operating data are calculated, becomes greater so that a better result can be achieved for subsequent methods.

The control parameters are therefore no longer based only on the experiences of the pump manufacturer, obtained within a test environment, but also on the experience obtained with the metering device.

In a further preferred embodiment of the invention the control device is provided on the sensor. Therefore the actuator, the sensor and the communication interface are of such a nature that an electrical measurement signal at the sensor output is transmitted by way of the communication interface to the remote server and an electrical actuation signal is received by way of the communication interface and transmitted to the actuator input.

In other words, the actual control task is transmitted from the metering device to the remote server. The metering device itself therefore only has to be in a position of transmitting the electrical measurement signals at the sensor output to the remote server and receiving a corresponding electrical actuation signal for the actuator input from the remote server.

The communication interface can be for example a network interface, that is to say an interface which permits the sensor and the actuator access to a computer network. In this case the server must also have a corresponding communication interface in the form of a network interface in order also to permit the server access to the computer network.

In a further preferred embodiment in step B) at least two metering devices, preferably at least ten metering devices and particularly preferably at least 100 metering devices are provided.

Basically the server can monitor or communicate with all metering devices that the metering device manufacturer sells. The individual metering devices then make available a multiplicity of data sets which can all be entered in the case database, on the basis of which then optimised operating data like for example control parameters can be calculated.

In a further preferred embodiment the metering device has a second sensor for detecting a second physical or chemical measurement value, which has a sensor output for a second electrical measurement signal and is so adapted that it detects the second physical or chemical measurement value, converts it into a second electrical measurement signal and makes same available at the sensor output, wherein in step D) data which contain the second electrical measurement signal or were calculated on the basis of the second electrical measurement signal are additionally transmitted from the metering device to the server by way of the communication interface.

Basically all items of information available in the metering device about the operating state of the metering device can be transmitted to the server in order to provide the software on the server with a comprehensive picture about the state of the metering device, on the basis of which, with the assistance of the reference data, the case database can calculate suitably optimised operating data for the control device.

In a further preferred embodiment a differential equation is set up for the displacement element, based on a physical model. In that case the first sensor measures at least the position of the displacement element and a physical variable of the displacement pump is determined on the server by means of the differential equation. For example the fluid pressure can be selected as the physical variable.

Measurement of the position of the displacement element can be effected for example in contact-free fashion and is generally effected in any case in the described metering pumps so that the information about the currently prevailing position of the displacement element is available. The differential equation can be for example a physical equation of motion of the displacement element and take account of all forces acting on the displacement element. Besides the force applied to the displacement element by the drive that is also the counteracting force applied to the diaphragm by the fluid pressure in the metering chamber and thus applied to the displacement element.

Therefore, if the force applied to the displacement element by the drive is known, conclusions about the fluid pressure in the metering head can be drawn from the position of the displacement element, or from the speed or acceleration of the displacement element, which can be deduced therefrom.

The pattern in respect of time of the fluid pressure in the metering chamber at the beginning of the pressure stroke, that is to say at the beginning of the movement of the diaphragm from the one position into the other position, allows conclusions to be drawn about the operating state of the diaphragm.

It is therefore possible in accordance with the invention that in particular the pattern in respect of time of the fluid pressure is determined and, for the situation where the determining operation shows that diaphragm fatigue is present, the metering pump is correspondingly shut down or at least a suitable warning message is produced.

In a particularly preferred embodiment it is therefore provided that the given physical variable is compared to a target value curve and if the given physical variable deviates from the target value curve by more than a predetermined tolerance value an alarm device is activated or the metering device is shut down.

In a further preferred embodiment it is provided that a magnetic coil is provided as the actuator and the current through the magnetic coil is detected with the first or the second sensor.

The server does not have to be arranged in the same room or space as the metering device, but can be arranged for example in an adjacent room or in any room which has a suitable process control system. Particularly preferably the communication interface is such that it can communicate by way of the Internet so that the remote server can be disposed at any location, for example at the metering device manufacturer. Particularly in the latter case the metering system can have a multiplicity of metering devices which all communicate with the remotely arranged server.

In a particularly preferred embodiment the sensor has a sensor operational input for an electrical operating signal, wherein there is provided an operating signal generating device which can generate an electrical operating signal and is connected to the sensor operational input, wherein the operating signal generating device is so adapted that it can communicate by way of the communication interface with a remotely arranged server.

In a preferred embodiment the control device has an operating signal generating device for the first sensor or is connected thereto, wherein in step F) the further operating data include improved values for operating signals for the first sensor and same are provided in step G) for the control device. There are sensors which, to obtain a measurement signal, must be supplied with an operating voltage, the magnitude and resolution of the measurement signal is influenced by the operating voltage. The optimum operating voltage of the sensor however depends not only on the current application situation, but for example also on the age of the sensor. Thus it may be that, in the course of time, the optimum operating voltage of the sensor rises or falls. On the basis of the transmitted measurement signal, it is possible to determine on the server whether it has the desired level and resolution. By comparison with data in the case database, it is possible to calculate an optimum operating voltage and provide same for the control device.

There are sensors which from time to time have to go through an activation mode in order to be able to ensure full functional capability of the sensor.

That is the case for example with amperometric sensors like for example a chlorine sensor. The manner of activation can depend on various factors like for example the specific situation of use, the nature of the medium to be conveyed, the variation in concentration in respect of time or the age of the sensor.

In a preferred embodiment the first sensor has an activation signal input and the control device has an activation signal generating device for the first or is connected thereto. In step F) the further operating data include improved values for activation signals for the first sensor and same are provided to the control device in step G).

If for example after delivery of the metering device with a corresponding sensor it turns out that after a certain operating time of the sensor the strength of the measurement signal falls the activation mode of operation for increasing the measurement signal can be triggered by communication with the server. The moment in time of the activation mode is then calculated on the basis of the values input in the case database.

In a preferred embodiment the sensor can be disposed in the metering chamber. Alternatively the sensor can detect an operating parameter of the drive of the displacement element. Operating parameters of the actuator can be for example the position of the displacement element or the voltage or the current at the actuator.

Further advantages, features and possible uses of the present invention will be clearly apparent from the description hereinafter of an embodiment according to the invention and the accompanying FIGURE in which:

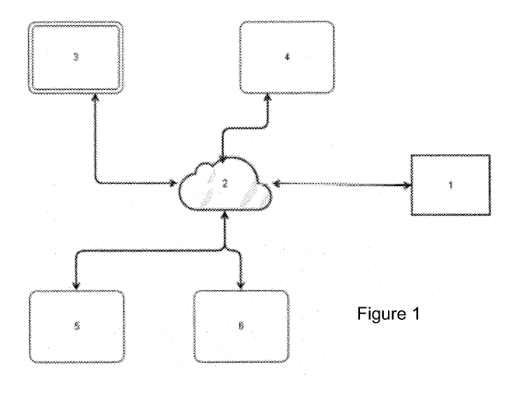

FIG. 1 shows a diagrammatic view of a system according to the invention.

FIG. 1 shows a diagrammatic view of a system according to the invention. In the illustrated embodiment the metering device 1 only comprises the conveyor unit with the corresponding drive including actuator and at least one sensor and a communication interface. The metering device 1 is connected to a server 2 which can also be completely virtualised. The server is in communication with a display device 3 which can be for example a PC, a smartphone or a tablet computer, by way of which it is possible to have access by means of remote access to the server 2 and by way of the server 2 to the metering device.

The server 2 takes over all tasks which are necessary for regular operation of the metering device. Besides the provision of computing power this is inter alia the closed-loop control function, that is to say the server 2 which is arranged at any remote location receives the measurement parameters necessary for control by way of the communication interface from the metering device 1 and outputs a corresponding actuation signal for the actuator, which in turn is transmitted to the metering device 1.

The server 2 has access to a case database 6 with reference data. The server can look up in that case database whether suitable operating data for the control device are already stored there, for comparable application cases. If same are present they can be transmitted to the control device. Optionally corresponding operating data can be interpolated or extrapolated from a plurality of data.

Particularly when no suitable reference data are available the control parameters of the control device can be entered into the case database in order to have access to the corresponding reference data in the event of a future similarly occurring case.

The corresponding data transmitted from the metering device are analysed in the server continuously or at regular intervals. If in that case it turns out that individual measurement values are outside a predetermined value, then an emergency shutdown can be initiated or an alarm device 5 can be activated, which passes a suitable warning message to the user for example by way of SMS, e-mail or Twitter.

In addition differential equations can be stored in the server on the basis of physical models, the coefficients of which equations describe physical properties of the system. Those coefficients should usually remain constant in normal operation, but in the course of operation if it turns out that the values for the coefficients alter significantly, that is a sign of material fatigue so that the corresponding service 4 can be informed that suitable maintenance of the metering device 1 is necessary.

### LIST OF REFERENCES

1 metering device
2 server
3 display device
4 service
5 alarm device
6 case database

1. A method of operating at least one metering device (1), wherein the method comprises the steps:
A) providing a server (2),
B) providing at least one metering device (1) having a metering chamber in which a displacement element is arranged moveably in such a way that it is reciprocable between two positions, wherein the volume of the metering chamber in the one position is greater than in the other position, wherein the metering device (1) further has:
an actuator for driving the displacement element, which has an actuator input for an electrical actuation signal and is so constructed that an electrical actuation signal at the actuator input is converted into a mechanical movement,
a first sensor for detecting a physical or chemical measurement value which has a sensor output for an electrical measurement signal and is so adapted that it detects the physical or chemical measurement value, converts it into an electrical measurement signal and makes same available at the sensor output,
a communication interface, by way of which the metering device (1) can communicate with the server (2),
C) providing a closed-loop control device which receives the electrical measurement signal provided at the sensor output, compares it to a predetermined target value and in dependence on the comparison result and further operating data generates an electrical actuation signal and outputs it to the actuator input,
D) transmitting data which contain the electrical measurement signal or were calculated on the basis of the electrical measurement signal, from the metering device (1) to the server (2) by way of the communication interface,
E) providing a case database (6) having reference data,
F) calculating improved further operating data from the transmitted data and the reference data, and
G) providing the improved further operating data for the control device.

2. A method according to claim 1 characterised in that the transmitted data are entered as further reference data into the case database (6).

3. A method according to claim 1 characterised in that the control device is provided on the server (2).

4. A method according to claim 1 characterised in that in step B) at least two metering devices (1) are provided.

5. A method according to claim 1 characterised in that the metering device (1) has a second sensor for detecting a second physical or chemical measurement value, which has a sensor output for a second electrical measurement signal and is so adapted that it detects the second physical or chemical measurement value, converts it into a second electrical measurement signal and makes same available at the sensor output, wherein in step D) data which in addition contain the second electrical measurement signal or were calculated on the basis of the second electrical measurement signal are transmitted from the metering device (1) to the server (2) by way of the communication interface.

6. A method according to claim 1 characterised in that a differential equation based on a physical model is set up for the displacement element, the first sensor measures at least the position of the displacement element and a physical variable of the displacement pump is determined on the server (2) by means of the differential equation.

7. A method according to claim 6 characterised in that the given physical variable is compared to a target value curve and if the given physical variable deviates from the target value curve by more than a predetermined tolerance value an alarm device is activated or the metering device (1) is shut down.

8. A method according to claim 1 characterised in that a magnetic coil is provided as the actuator and the current through the magnetic coil is detected with the first or the second sensor.

9. A method according to claim 1 characterised in that the first sensor has an operational signal input and the control device has an operating signal generating device for the first sensor or is connected thereto and in step F) the further operating data improved values for operational signals for the first and second sensor are calculated and same are provided for the control device in step G).

10. A method according to claim 1 characterised in that the first sensor has an activation signal input and the control device has an activation signal generating device for the first and/or second sensor or is connected thereto and in step F) the further operating data improved values for activation signals for the first sensor are calculated and provided in step G) for the control device.

11. A method according to claim 1 characterised in that the transmitted data together with at least a part of the further operating data are entered as further reference data into the case database (6).

12. A method according to claim 1 characterised in that the transmitted data together with the data calculated from the transmitted data are entered as further reference data into the case database (6).

13. A method according to claim 1 characterised in that the transmitted data together with at least a part of the further operating data and from at least a part of the further operating data are entered as further reference data into the case database (6).

14. A method according to claim 1 characterised in that the transmitted data together with data calculated from the transmitted data and from at least a part of the further operating data are entered as further reference data into the case database (6).

15. A method according to claim 1 characterised in that in step B) at least ten metering devices (1) are provided.

16. A method according to claim 1 characterised in that in step B) at least 100 metering devices (1) are provided.
